(19) United States
(12) Patent Application Publication
(10) Pub. No.: US 2022/0135379 A1
(43) Pub. Date: May 5, 2022

(54) CARGO CONTAINER IMAGE CAPTURING METHOD AND SYSTEM APPLIED TO BRIDGE CRANE

(71) Applicant: INSTITUTE FOR INFORMATION INDUSTRY, Taipei City (TW)

(72) Inventors: Chih-Hsiang HO, Taipei (TW); Mao-Chi HUANG, Taipei (TW)

(73) Assignee: INSTITUTE FOR INFORMATION INDUSTRY, Taipei City (TW)

(21) Appl. No.: 16/950,386

(22) Filed: Nov. 17, 2020

(30) Foreign Application Priority Data
Nov. 3, 2020 (TW) 109138240

(51) Int. Cl. B66C 13/46; B66C 13/16; B66C 19/00; G06K 9/20; G06K 9/00; B66C 13/02

(52) U.S. Cl. CPC B66C 13/46; B66C 13/16; B66C 19/002; B66C 2700/08; G06K 9/00201; B66C 13/02; G06K 9/20

(57) ABSTRACT

A cargo container image capturing method and system applied to a bridge crane are provided. The cargo container image capturing method includes the following steps. A human-machine interface (HMI) image of an HMI of the bridge crane is captured. Several values are obtained from the HMI image using an image recognition algorithm. At least one camera is controlled to capture a cargo container image according to the values.

This application claims the benefit of Taiwan application Serial No. 109138240, filed Nov. 3, 2020, the subject matter of which is incorporated herein by reference.

### BACKGROUND OF THE INVENTION

### Field of the Invention

The invention relates in general to an image capturing method and system, and more particularly to a cargo container image capturing method and system applied to a bridge crane.

### Description of the Related Art

As the commercial intercourse between countries is increasing, every day at each commercial port around the world, many cargo containers are unmounted to the container cars from the cargo vessels or the other way round. At each commercial port, the cargo containers are mounted and unmounted through the gripping and placing of the bridge crane.

To avoid the bridge crane gripping a wrong cargo container or to clarify the liability for the damage of the cargo container, a shipment company normally would either hire specific personnel to monitor the gripping and placing of the cargo container beside the bridge crane or install a cargo container image capturing system to capture the image of the cargo container. Both solutions will cause extra cost. If the shipment company decides to install a cargo container image capturing system to precisely capture the cargo container image, the shipping company needs to coordinate with the factory of the bridge crane for enabling the cargo container image capturing system to interface with the electro-control system, and a large amount of extra cost will occur.

### SUMMARY OF THE INVENTION

The invention is directed to a cargo container image capturing method and system applied to a bridge crane capable of precisely capturing the image of the cargo container without interfacing with the electro-control system of the bridge crane image and therefore saving cost.

According to one embodiment of the present invention, a cargo container image capturing method applied to a bridge crane is provided. The cargo container image capturing method includes the following steps. A human-machine interface (HMI) image of an HMI of the bridge crane is captured. Several values are obtained from the HMI image using an image recognition algorithm. At least one camera is controlled to capture a cargo container image according to the values.

According to another embodiment of the present invention, a cargo container image capturing system applied to a bridge crane is provided. The cargo container image capturing system includes at least one camera, a human-machine interface (HMI) image capturing unit, and a processing unit. The HMI image capturing unit is used to capture an HMI image of an HMI of the bridge crane. The processing unit is used to obtain several values from the HMI image using an image recognition algorithm, and to control at least one camera to capture a cargo container image according to the values.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a bridge crane;

FIG. 2 is a schematic diagram of an HMI;

FIG. 3 is a system architecture diagram of a cargo container image capturing system applied to a bridge crane according to an embodiment of the present invention;

FIG. 4 is a flowchart of a cargo container image capturing method applied to a bridge crane according to an embodiment of the present invention;

FIG. 5 is a flowchart of a cargo container image capturing method applied to a bridge crane according to another embodiment of the present invention;

FIG. 6 is a schematic diagram of a state of the cargo container prior to being gripped on the landside according to an embodiment of the present invention;

FIG. 7 is a schematic diagram of a state of the cargo container gripped on the seaside according to an embodiment of the present invention;

FIG. 8 is a schematic diagram of a state of the cargo container after placement on the landside according to an embodiment of the present invention;

FIG. 9 is a schematic diagram of a state of the cargo container after placement at the seaside according to an embodiment of the present invention;

FIG. 10 is a flowchart of a cargo container image capturing method applied to a bridge crane according to another embodiment of the present invention;

FIG. 11 is a schematic diagram of a bridge crane and lanes according to an embodiment of the present invention;

FIG. 12 is a schematic diagram of a gripping state according to an embodiment of the present invention; and

FIG. 13 is a schematic diagram of a placing state according to an embodiment of the present invention.

### DETAILED DESCRIPTION OF THE INVENTION

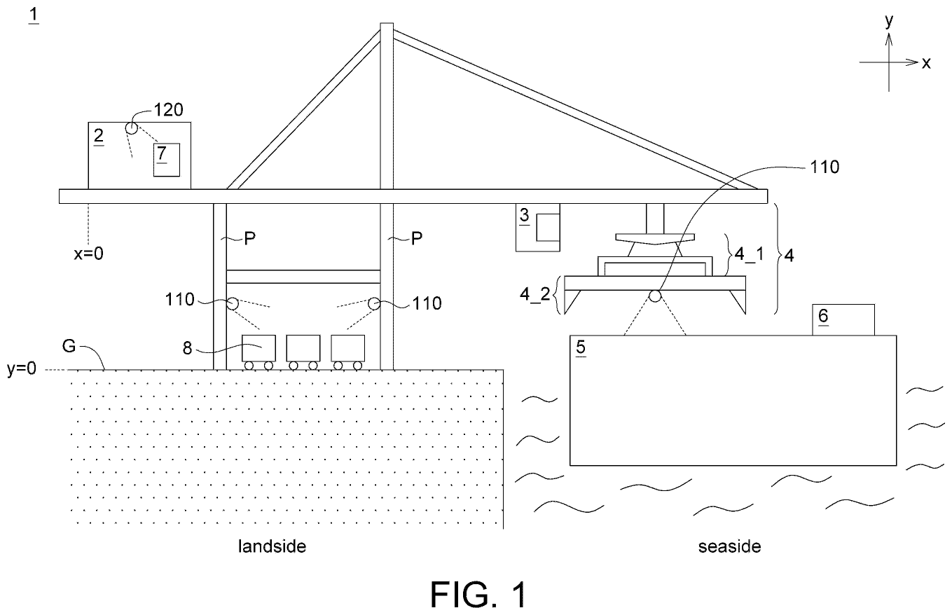

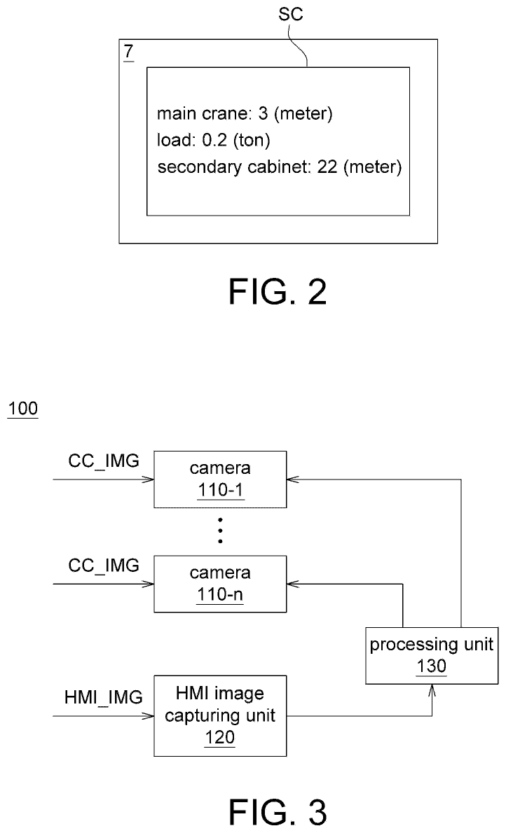

Refer to FIGS. 1 and 2. FIG. 1 is a schematic diagram of the bridge crane 1. FIG. 2 is a schematic diagram of an HMI 7. The bridge crane 1 has a main cabinet 2, a secondary cabinet 3, and a main crane 4. The operator at the secondary cabinet 3 can operate the main crane 4 to grip a cargo container 6 to a container car 8 on the landside from a cargo vessel 5 on the seaside, or grip a cargo container 6 to a cargo vessel 5 on the seaside from a container car 8 on the landside. Each container car 8 parks on a lane (not illustrated). The secondary cabinet 3 and the main crane 4 move along the X-axis direction concurrently. Moreover, the main crane 4 can move along the Y-axis direction. The main crane 4 includes an upper hanger 4_1 and a lower hanger 4_2. The main cabinet 2 has a human-machine interface (HMI) 7. The screen SC of the HMI 7 displays several values relevant to the bridge crane 1. For example, the screen SC displays at least one main crane value, a load value, and a secondary cabinet value. The main crane value represents the position of the main crane 4 in the Y-axis direction. When the lower hanger 4_2 is placed on the ground G of the bridge crane 1 and the lower hanger 4_2 is level with the ground G, the main crane value is equal to 0 (Y=0) (as original point). After the lower hanger 4_2 leaves the ground G, the main crane value is the distance (meter) from the lowest point of the lower hanger 4_2 to the ground G. The load value represents the load (ton) on the main crane 4, that is, the sum of the weight of the main crane 4 itself plus the weight of the cargo container 6, and the initial value of the load value is the weight of the main crane 4 itself.

Suppose the weight of the main crane itself is about 300 kilograms, then the initial value of the load value before the main crane 4 grips any cargo container is 0.3 (ton). The secondary cabinet value represents the position of the secondary cabinet 3 in the X-axis direction. The position of the main cabinet 2 on the landside is defined as the original point (X=0). It should be noted that the original point of the main crane value, the initial value of the load value, and the original point of the secondary cabinet value can be adjusted according to the situation of the bridge crane 1, and the setting of the original point of the main crane value, the setting of the initial value of the load value and the setting of the original point of the secondary cabinet value are not intended to limit the present invention.

Referring to FIG. 3, a system architecture diagram of a cargo container image capturing system 100 applied to a bridge crane 1 according to an embodiment of the present invention is shown. The cargo container image capturing system 100 includes at least one camera 110-1, . . . , 110-n, an HMI image capturing unit 120, and a processing unit 130. The cameras 110-1, . . . , 110-n can be realized by digital cameras or movable pan tilt zoom (PTZ) cameras. The HMI image capturing unit 120 can be realized by a plug-in camera. The HMI image capturing unit 120 can be disposed in the main cabinet 2 (as indicated in FIG. 1) to video or photograph the screen SC of the HMI 7. The processing unit 130 can be realized by a chip, a circuit board, or a circuit. In an embodiment, at least one camera 110-1, . . . , 110-n can be disposed on the lower hanger 4_2 (as indicated in FIG. 1) to video or photograph the cargo container 6 under the main crane 4. In another embodiment, at least one camera 110-1, . . . , 110-n can be four PTZ cameras respectively disposed on several pillars P of the bridge crane 1 (as indicated in FIG. 1) to video or photograph the cargo container 6 above the lane.

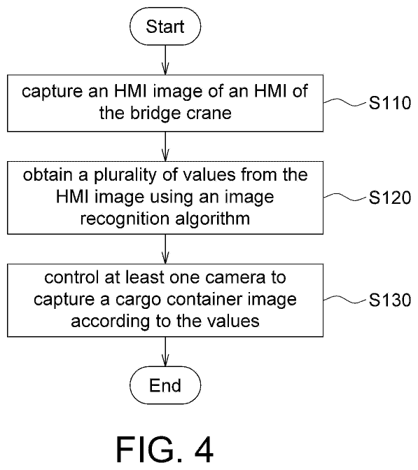

Referring to FIG. 4, a flowchart of a cargo container image capturing method applied to a bridge crane 1 according to an embodiment of the present invention is shown. In step S110, an HMI image HMI_IMG of an HMI 7 of the bridge crane 1 is captured by the HMI image capturing unit 120.

In step S120, several values are obtained from the HMI image by the processing unit 130 using an image recognition algorithm HMI_IMG. The values include a main crane value, a load value, and a secondary cabinet value. The processing unit 130 obtains the main crane value, the load value, and the secondary cabinet value from the HMI image HMI_IMG through optical character recognition (OCR).

In step S130, at least one camera 110-1, . . . , 110-n is controlled by the processing unit 130 to capture a cargo container image CC_IMG according to the values. Furthermore, the processing unit 130 determines the operation status of the bridge crane 1 according to the variation in the values such as the main crane value, the load value, and the secondary cabinet value, and controls at least one camera 110-1, . . . , 110-n to capture a cargo container image CC_IMG of the cargo container 6 according to the operation status.

Through steps S110 to S130, the cargo container image CC_IMG can be precisely captured, an image recognition process can be performed on the cargo container image CC_IMG to correctly obtain the container number of the cargo container and correctly determine whether the appearance of the cargo container is damaged or not, such that the wrong the cargo container will not be gripped by the bridge crane and the liability for the damaged the cargo container can be clarified.

The cargo container image capturing system 100 of the present invention can obtain several values relevant to the bridge crane 1 according to the HMI image HMI_IMG, and determine the operation status of the bridge crane 1 according to the obtained values to control at least one camera 110-1, . . . , 110-n to capture the cargo container image CC_IMG. Thus, the cargo container image capturing system 100 of the present invention, without interfacing with the electro-control system of the bridge crane 1, can precisely capture the cargo container image CC_I MG and therefore can save cost.

Detailed descriptions of each embodiment are disclosed below.

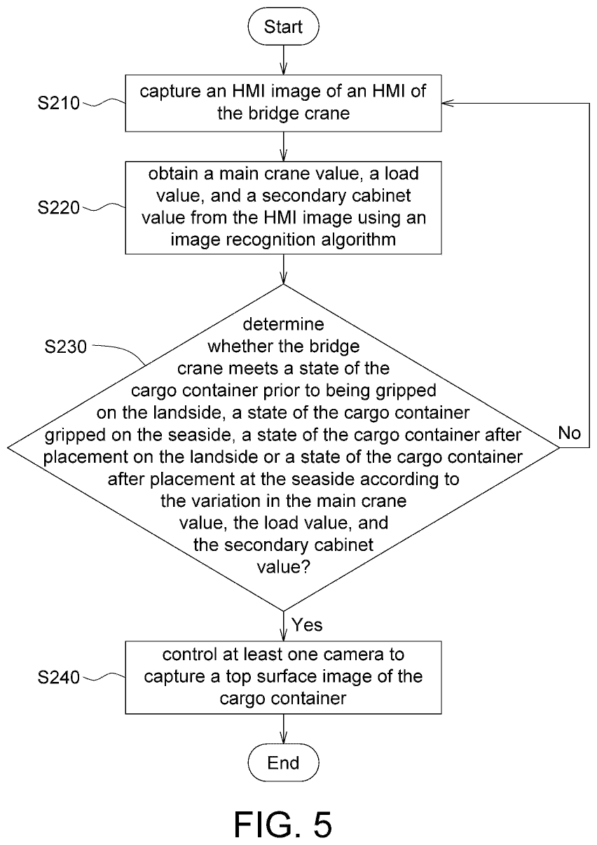

Refer to FIGS. 1, 2, 3, and 5. FIG. 5 is a flowchart of a cargo container image capturing method applied to a bridge crane 1 according to another embodiment of the present invention. In the present embodiment, at least one camera 110-1, . . . , 110-n of the cargo container image capturing system 100 is disposed on the lower hanger 4_2 to video or photograph the cargo container 6 under the main crane 4 to obtain a cargo container image

CC_IMG. The cargo container image CC_IMG is a top surface image of the cargo container 6. Since the container number of the cargo container is normally marked on the top surface, the top surface image of the cargo container can be precisely captured through the method of FIG. 5. Then, an image recognition process can be performed on the top surface image to correctly obtain the container number of the cargo container and correctly determine whether the top surface of the cargo container is damaged or not.

In step S210, an HMI image HMI_IMG of an HMI 7 of the bridge crane 1 is captured by the HMI image capturing unit 120.

In step S220, a main crane value, a load value, and a secondary cabinet value are obtained from the HMI image by the processing unit 130 using an image recognition algorithm HMI_IMG.

In step S230, whether the bridge crane 1 meets a state of the cargo container prior to being gripped on the landside, a state of the cargo container gripped on the seaside, a state of the cargo container after placement on the landside or a state of the cargo container after placement at the seaside is determined by the processing unit 130 according to the variation in the main crane value, the load value, and the secondary cabinet value. If the bridge crane 1 meets one of the above statuses, the method proceeds to step S240; otherwise, the method returns to step S210.

Since the secondary cabinet 3 and the main crane 4 move along the X-axis direction concurrently, the processing unit 130 determines whether the secondary cabinet 3 and the main crane 4 are located on the landside or the seaside according to the secondary cabinet value. For example, if the secondary cabinet value is smaller than the secondary cabinet threshold value, this implies that the secondary cabinet 3 and the main crane 4 are on the landside; if the secondary cabinet value is larger than the secondary cabinet threshold value, this implies that the secondary cabinet 3 and the main crane 4 are on the seaside. In an embodiment of the present invention, the secondary cabinet threshold value can be correspondingly adjusted according to the distance between the secondary cabinet 3 and the main cabinet 2. In other embodiments, the secondary cabinet threshold value can be set according to the distance between the secondary cabinet 3 and the corresponding lane. In other embodiments, the secondary cabinet threshold value can also be set according to the distance between the main cabinet 2 and the water-land boundary of the wharf. Besides, the processing unit 130 determines whether the main crane 4 has gripped the cargo container according to the load value.

For example, if the load value is smaller than the load threshold value, this implies that the main crane 4 does not grip any cargo container; if the load value is larger than the load threshold value, this implies that the main crane 4 has already gripped the cargo container. That is, the load threshold value is set as the weight of the main crane itself, such as 0.3 (ton). In an embodiment of the present invention, the load threshold value can be correspondingly adjusted according to the weight of the main crane 4 itself, and the larger the weight of the main crane 4 itself, the larger the load threshold value. Also, the processing unit 130 determines the height or depth from the main crane 4 to the ground G according to the main crane value. For example, if the main crane value is equal to 5, this implies that the height from the main crane 4 to the ground G is 5 meters; if the main crane value is equal to −2, this implies that the depth from the main crane 4 to the ground G is 2 meters. In one embodiment of the application, the main crane value is compared with a main crane predetermined value to determine a distance between the camera 110-1, . . . , 110-n of the main crane 4 and a top surface of the cargo container 6, for determining whether to capture images. The main crane predetermined value is adjusted based on a relative distance between the height of the cargo container 6 and the main crane 4. In details, the main crane predetermined value is adjusted based on a relative distance between the main crane 4 and the top surface of the cargo container 6. If the height of the cargo container 6 is higher (i.e. the distance between the ground G and the top surface of the cargo container 6 is larger), then the main crane predetermined value is larger.

In one embodiment, the secondary cabinet threshold value is set as 20 in the case that the distance between the secondary cabinet 3 and the main cabinet 2 is about 20 meters. The application is not limited by this. In one embodiment, the main crane predetermined value is set as 5 in the case that the distance between the main crane 4 and the top surface of the cargo container 6 is about 3 meters. The application is not limited by this. In one embodiment, the range of the main crane predetermined value (as referred as “the predetermined main crane range”) is about between 4 (a lower limit of the predetermined main crane range) and 6 (an upper limit of the predetermined main crane range), that is, the distance between the main crane 4 and the top surface of the cargo container 6 is about between 2 meters and 4 meters. Preferably, the predetermined main crane range is between 4.5 and 5.5 (i.e. the distance between the main crane 4 and the top surface of the cargo container 6 is about between 2.5 meters and 3.5 meters).

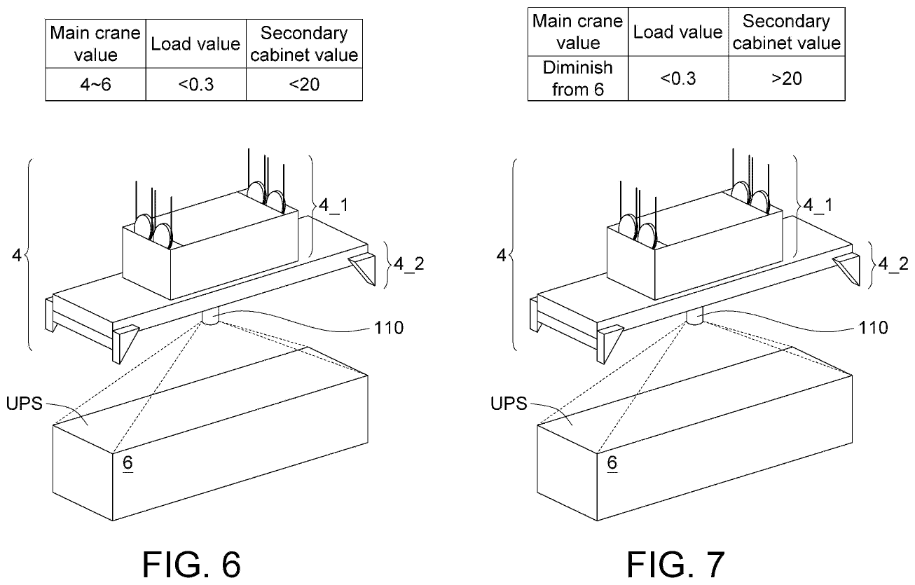

FIG. 6 is a schematic diagram of a state of the cargo container prior to being gripped on the landside according to an embodiment of the present invention. The processing unit 130 determines whether the bridge crane 1 meets the state of the cargo container prior to being gripped on the landside. If the secondary cabinet value is smaller than the secondary cabinet threshold value, the load value is smaller than the load threshold value, and the main crane value is within the predetermined main crane range (the main crane value not within the predetermined main crane range does not meet the state of the cargo container prior to being gripped on the landside), then the processing unit 130 determines that the bridge crane 1 meets the state of the cargo container prior to being gripped on the landside. In the embodiment of FIG. 6, if the secondary cabinet value is smaller than the secondary cabinet threshold value 20, the load value is smaller than the load threshold value 0.3, and the main crane value is within the predetermined main crane range 4-6, then the processing unit 130 determines that the bridge crane 1 meets the state of the cargo container prior to being gripped on the landside.

FIG. 7 is a schematic diagram of a state of the cargo container gripped on the seaside according to an embodiment of the present invention.

The processing unit 130 determines whether the bridge crane 1 meets the state of the cargo container gripped on the seaside. If the secondary cabinet value is larger than the secondary cabinet threshold value, the load value originally smaller than the load threshold value changes to be larger than the load threshold value, and the main crane value diminishes, then the processing unit 130 determines that the bridge crane 1 meets the state of the cargo container gripped on the seaside. To put it in greater details, if the secondary cabinet value is larger than the secondary cabinet threshold value, the main crane value diminishes, and the load value is smaller than the load threshold value, then the processing unit 130 determines that the bridge crane 1 meets a start condition; if the secondary cabinet value is larger than the secondary cabinet threshold value and the load value originally smaller than the load threshold value changes to be larger than the load threshold value, then the processing unit 130 determines that the bridge crane 1 meets a stop condition; if the bridge crane 1 is within the period between the start condition and the stop condition, then the processing unit 130 determines that the bridge crane 1 meets the state of the cargo container gripped on the seaside. In the embodiment of FIG. 7, if the secondary cabinet value is larger than the secondary cabinet threshold value 20, the load value is smaller than the load threshold value 0.3, and the main crane value from 6 diminishes, then the processing unit 130 determines that the bridge crane 1 meets the state of the cargo container gripped on the seaside.

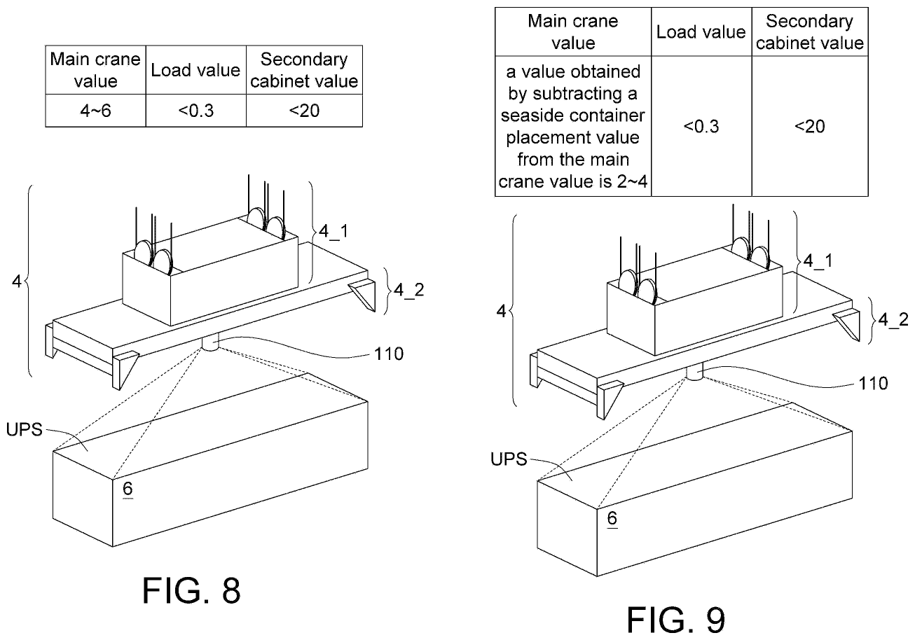

FIG. 8 is a schematic diagram of a state of the cargo container after placement on the landside according to an embodiment of the present invention. The processing unit 130 determines whether the bridge crane 1 meets the state of the cargo container after placement on the landside. If the secondary cabinet value is smaller than the secondary cabinet threshold value, the load value is smaller than the load threshold value, and the main crane value is within the predetermined main crane range, then the processing unit 130 determines that the bridge crane 1 meets the state of the cargo container after placement on the landside. In the embodiment of FIG. 8, if the secondary cabinet value is smaller than the secondary cabinet threshold value 20, the load value is smaller than the load threshold value 0.3, and the main crane value is within the predetermined main crane range 4-6, then the processing unit 130 determines that the bridge crane 1 meets the state of the cargo container after placement on the landside.

FIG. 9 is a schematic diagram of a state of the cargo container after placement at the seaside according to an embodiment of the present invention.

The processing unit 130 determines whether the bridge crane 1 meets the state of the cargo container after placement at the seaside. During the seaside placement process, the secondary cabinet value is larger than the secondary cabinet threshold value, the main crane value diminishes (the main crane 4 gripping the cargo container 6 is descending), and the load value originally larger than the load threshold value changes to be smaller than the load threshold value (the main crane 4, which originally gripped the cargo container 6, has unmounted the cargo container 6); meanwhile, the main crane 4 has already unmounted the cargo container 6 to a predetermined position on the ship, the current main crane value is stored as the seaside container placement value, and the main crane value again swells (the main crane 4 not gripping the cargo container 6 is ascending). If the secondary cabinet value is larger than the secondary cabinet threshold value, the load value is smaller than the load threshold value, and the main crane value swells, then the processing unit 130 determines that the bridge crane meets the state of the cargo container after placement at the seaside. To put it in greater details, the state of the cargo container after placement at the seaside is set as: the secondary cabinet value is larger than the secondary cabinet threshold value, the load value is smaller than the load threshold value, and the value obtained after comparing the value of the main crane with the seaside container placement value is within a predetermined sea crane range (i.e. a value obtained by subtracting a seaside container placement value from the main crane value is within the predetermined sea crane range). The predetermined sea crane range can be set as 2-4 or 2.5-3.5, which represents the distance from the main crane 4 to the top surface of the cargo container 6. The distance from the main crane 4 to the top surface of the cargo container 6 can be exemplified by about 2-4 or 2.5-3.5 meters, but the invention is not limited to the said exemplification. In the embodiment of FIG. 9, if the secondary cabinet value is larger than the secondary cabinet threshold value 20, the load value is smaller than the load threshold value 0.3, and a value obtained by subtracting a seaside container placement value from the main crane value is 2-4, then the processing unit 130 determines that the bridge crane 1 meets the state of the cargo container after placement at the seaside.

It should be noted that the secondary cabinet threshold value, the load threshold value, and the predetermined main crane value are exemplified above for a convenience purpose, not for limiting the present invention.

In step S240, at least one camera 110-1, . . . , 110-n is controlled by the processing unit 130 to capture a top surface image of the top surface UPS of the cargo container 6. In an embodiment, the processing unit 130 controls at least one camera 110-1, . . . , 110-n to capture several top surface images of the top surface UPS of the cargo container 6 or video the top surface UPS of the cargo container 6 for a period of time to capture the top surface images. That is, the top surface image can be a photo, several photos, or a film. In the above exemplification, a camera is disposed on the lower hanger 4_2, but in other embodiments, at least one camera 110-1, . . . , 110-n of the cargo container image capturing system 100 can be two cameras both disposed on the lower hanger 4_2 to video or photograph the cargo container 6 under the main crane 4 to obtain the top surface image of the top surface UPS of the cargo container 6. However, the present invention is not limited to the above exemplification, and any arrangement allowing the top surface image of the top surface UPS of the cargo container under the main crane 4 to be obtained would do. That is, if the bridge crane meets one of the state of the cargo container prior to being gripped on the landside, the state of the cargo container gripped on the seaside, the state of the cargo container after placement on the landside or the state of the cargo container after placement at the seaside, the top surface image of the top surface UPS of the cargo container 6 obtained by photographing the cargo container 6 under the main crane 4 can be performed at any time point within the predetermined main crane range or the predetermined sea crane range. In an embodiment, if the bridge crane meets any one of the state of the cargo container prior to being gripped on the landside, the state of the cargo container gripped on the seaside, the state of the cargo container after placement on the landside or the state of the cargo container after placement at the seaside and the following gripping state or placing state or any point in any state, the processing unit 130 controls the at least one camera 110-1, . . . , 110-n to video (within the time of any one status) or photograph (at any time point of any one status) the top surface image of the top surface UPS of the cargo container 6.

Thus, through the method of FIG. 5 of the present invention, the cargo container image capturing system 100, without interfacing with the electro-control system of the bridge crane 1, can precisely capture the top surface image of the cargo container before the cargo container is gripped and after the cargo container is unmounted. Then, an image recognition process can be performed on the top surface image to correctly obtain the container number of the cargo container and correctly determine whether the top surface of the cargo container is damaged or not.

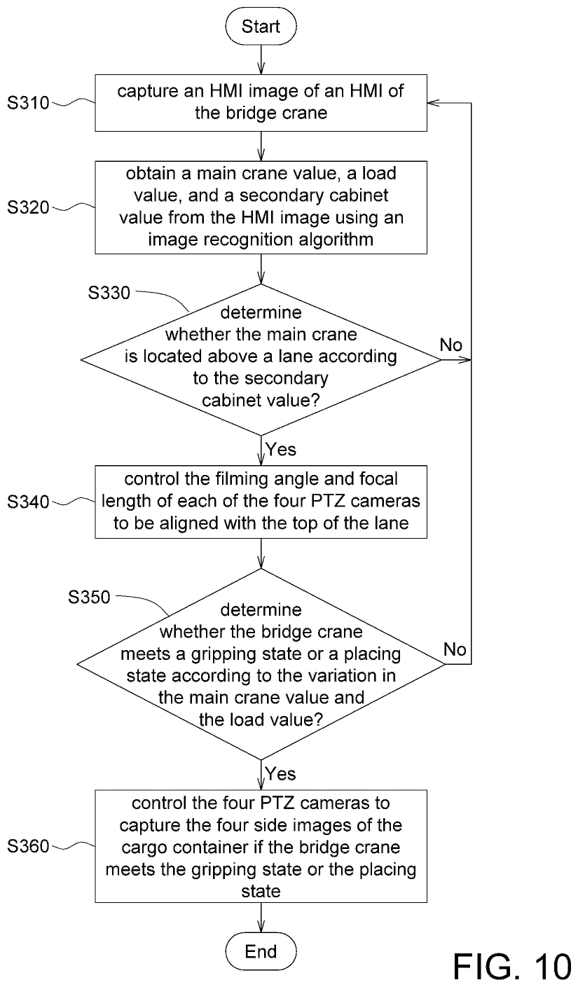

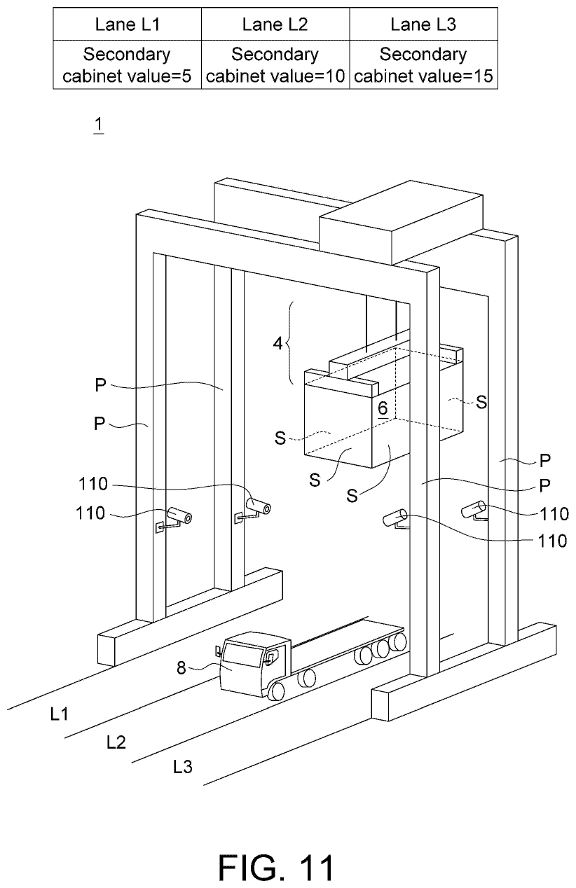

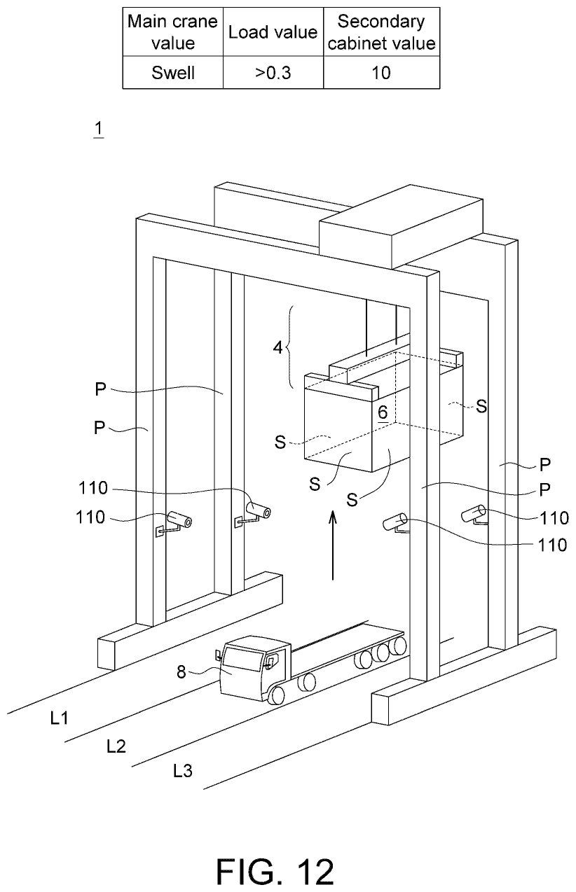

Refer to FIGS. 1, 2, 3, 10, and 11. FIG. 10 is a flowchart of a cargo container image capturing method applied to a bridge crane 1 according to another embodiment of the present invention. FIG. 11 is a schematic diagram of a bridge crane 1 and lanes L1, L2, and L3 according to an embodiment of the present invention. The bridge crane 1 has four pillars P, and the lanes L1, L2, and L3 are located within the four pillars P. In the present embodiment, at least one camera 110-1, . . . , 110-n of the cargo container image capturing system 100 includes four movable pan tilt zoom (PTZ) cameras respectively disposed on the four pillars P of the bridge crane 1 to video or photograph the cargo container 6 above the lane to obtain a cargo container image CC_IMG. The cargo container image CC_IMG includes four side images of four sides S of the cargo container 6. Through the method of FIG. 10, the four side images of four sides S of the cargo container 6 can be precisely captured. Then, an image recognition process can be performed on the four side images to correctly determine whether the four sides S of the cargo container are damaged or not.

In step S310, an HMI image HMI_IMG of an HMI 7 of the bridge crane 1 is captured by the HMI image capturing unit 120.

In step S320, a main crane value, a load value, and a secondary cabinet value are obtained from the HMI image by the processing unit 130 using an image recognition algorithm HMI_IMG. The main crane value is compared with a predetermined main crane value to confirm the distance from the cameras 110-1, . . . , 110-n disposed on the main crane 4 to the top surface of the cargo container 6 to determine whether the corresponding four side images of the cargo container 6 needs to be captured in the following steps. In an embodiment, the predetermined main crane value is set as the distance from the main crane 4 to the top surface of the cargo container 6. For example, the predetermined main crane value has a range of about 4-6 (that is, the distance from the main crane 4 to the top surface of the cargo container 6 is between about 2-4 meters), and preferably, about 4.5-5.5.

In step S330, whether the main crane 4 is located above a lane is determined by the processing unit 130 according to the secondary cabinet value. Since the positions of the lanes L1, L2, and L3 are relevant to the secondary cabinet value, the processing unit 130 determines whether the main crane 4 is located above the lanes L1, L2, or L3 according to the secondary cabinet value. For example, if the secondary cabinet value is about equal to the lane threshold value 5, then the processing unit 130 determines that the main crane 4 is located above the lane L1, if the secondary cabinet value is about equal to the lane threshold value 10, then the processing unit 130 determines that the main crane 4 is located above the lane L2; if the secondary cabinet value is about equal to the lane threshold value 15, then the processing unit 130 determines that the main crane 4 is located above the lane L3. It should be noted that the lane threshold value is exemplified above for convenience purposes, not for limiting the present invention.

In step S340, the filming angle and focal length of each of the four PTZ cameras are controlled by the processing unit 130 to be aligned with the top of the lane. For example, if the processing unit 130 determines that the main crane 4 is located above the lane L2, then the processing unit 130 controls the filming angle and focal length of each of the four PTZ cameras to be aligned with the top of the lane L2 to capture the four side images of the cargo container 6 above the lane L2. In an embodiment, the filming angle and focal length of each of the four PTZ cameras can be calibrated with respect to each lane in advance.

I n step S350, whether the bridge crane 1 meets a gripping state or a placing state is determined by the processing unit 130 according to the variation in the main crane value and the load value.

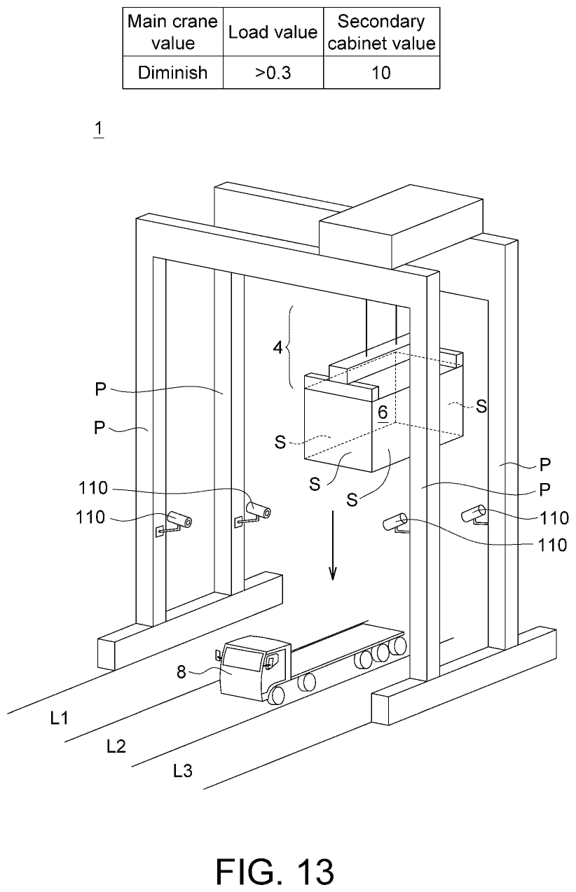

FIG. 12 is a schematic diagram of a gripping state according to an embodiment of the present invention. If the secondary cabinet value is smaller than the secondary cabinet threshold value, the load value is larger than the load threshold value, and the main crane value swells, then the processing unit 130 determines that the bridge crane 1 meets the gripping state, wherein the main crane value is within the predetermined main crane range.

FIG. 13 is a schematic diagram of a placing state according to an embodiment of the present invention. If the secondary cabinet value is smaller than the secondary cabinet threshold value, the load value is larger than the load threshold value, and the main crane value diminishes, then the processing unit 130 determines that the bridge crane 1 meets the placing state, wherein the main crane value is within the predetermined main crane range.

In step S360, if the processing unit 130 determines that the bridge crane 1 meets the gripping state or the placing state, the four PTZ cameras are controlled by the processing unit 130 to capture the four side images of the cargo container 6. In an embodiment, the four PTZ cameras are respectively disposed at a position higher than a height of the front of a container car 8, so that the four sides S of cargo container 6 will not be blocked by the front of the container car 8 when the four PTZ cameras capture the four side images.

Thus, through the method of FIG. 10 of the present invention, the cargo container image capturing system 100, without interfacing with the electro-control system of the bridge crane 1, can precisely capture the four side images of the cargo container when the cargo container is gripped or unmounted. Then, an image recognition process can be performed on the four side images to correctly determine whether the four sides of the cargo container are damaged or not.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cargo container image capturing method applied to a bridge crane, comprising:
capturing a human-machine interface (HMI) image of an HMI of the bridge crane;
obtaining a plurality of values from the HMI image using an image recognition algorithm; and
controlling at least one camera to capture a cargo container image according to the values.

2. The image capturing method according to claim 1, wherein the values comprise a main crane value, a load value and a secondary cabinet value.

3. The cargo container image capturing method according to claim 2, wherein the bridge crane comprises a main crane comprising a lower hanger and an upper hanger, the at least one camera is disposed on the lower hanger, and the cargo container image is a top surface image of a cargo container.

4. The cargo container image capturing method according to claim 3, further comprising:
determining whether the bridge crane meets a state of the cargo container prior to being gripped on the landside, a state of the cargo container gripped on the seaside, a state of the cargo container after placement on the landside, or a state of the cargo container after placement at the seaside according to a variation in the main crane value, the load value, and the secondary cabinet value; and
controlling the at least one camera to capture the top surface image of the cargo container if the bridge crane meets the state of the cargo container prior to being gripped on the landside, the state of the cargo container gripped on the seaside, the state of the cargo container after placement on the landside or the state of the cargo container after placement at the seaside;
wherein the top surface image is a photo or a film.

5. The cargo container image capturing method according to claim 4, further comprising:
determining that the bridge crane meets the state of the cargo container prior to being gripped on the landside if the secondary cabinet value is smaller than a secondary cabinet threshold value, the load value is smaller than a load threshold value, and the main crane value is within a predetermined main crane range;
determining that the bridge crane meets a start condition if the secondary cabinet value is larger than the secondary cabinet threshold value, the main crane value diminishes, and the load value is smaller than the load threshold value; determining that the bridge crane meets a stop condition if the secondary cabinet value is larger than the secondary cabinet threshold value and the load value originally smaller than the load threshold value changes to be larger than the load threshold value; determining that the bridge crane meets the state of the cargo container gripped on the seaside if the bridge crane is within a period between the start condition and the stop condition;
determining that the bridge crane meets the state of the cargo container after placement on the landside if the secondary cabinet value is smaller than the secondary cabinet threshold value, the load value is smaller than the load threshold value, and the main crane value is within the predetermined main crane range;
determining that the bridge crane meets the state of the cargo container after placement at the seaside if the secondary cabinet value is larger than the secondary cabinet threshold value, the load value is smaller than the load threshold value, and a value obtained by subtracting a seaside container placement value from the main crane value is within a predetermined sea crane range.

6. The cargo container image capturing method according to claim 2, wherein the at least one camera comprises four movable pan tilt zoom (PTZ) cameras, and the cargo container image includes four side images of a cargo container.

7. The cargo container image capturing method according to claim 6, wherein the bridge crane further comprises a main crane, and the cargo container image capturing method further comprises:
determining whether the main crane is located above a lane according to the secondary cabinet value;
controlling a filming angle and a focal length of each of the four PTZ cameras to be aligned with the top of the lane if it is determined that the main crane is located above the lane;
determining whether the bridge crane meets a gripping state or a placing state according to the variation in the main crane value and the load value;
controlling the four PTZ cameras to capture the four side images of the cargo container if the bridge crane meets the gripping state or the placing state;
wherein the four side images of the cargo container are photos or films.

8. The cargo container image capturing method according to claim 7, further comprising:
determining that the main crane is located above the lane if the secondary cabinet value is about equal to a lane threshold value;
determining that the bridge crane meets the gripping state if the main crane value swells and the load value is larger than a load threshold value; and
determining that the bridge crane meets the placing state if the main crane value diminishes and the load value is larger than the load threshold value.

9. The cargo container image capturing method according to claim 6, wherein the bridge crane further comprises four pillars, and the four PTZ cameras are respectively disposed on the four pillars at a position higher than a height of a front of a container car.

10. A cargo container image capturing system applied to a bridge crane, comprising:
at least one camera;
a human-machine interface (HMI) image capturing unit used to capture an HMI image of an HMI of the bridge crane; and
a processing unit used to obtain a plurality of values from the HMI image using an image recognition algorithm and to control the at least one camera to capture a cargo container image according to the values.

11. The cargo container image capturing system according to claim 10, wherein the values comprise a main crane value, a load value and a secondary cabinet value.

12. The cargo container image capturing system according to claim 11, wherein the bridge crane comprises a main crane comprising a lower hanger and an upper hanger, the at least one camera is disposed on the lower hanger, and the cargo container image is a top surface image of a cargo container.

13. The cargo container image capturing system according to claim 12, wherein the processing unit is further used to determine whether the bridge crane meets a state of the cargo container prior to being gripped on the landside, a state of the cargo container gripped on the seaside, a state of the cargo container after placement on the landside or a state of the cargo container after placement at the seaside according to a variation in the main crane value, the load value and the secondary cabinet value; and
if the bridge crane meets the state of the cargo container prior to being gripped on the landside, the state of the cargo container gripped on the seaside, the state of the cargo container after placement on the landside or the state of the cargo container after placement at the seaside, then the processing unit controls the at least one camera to capture the top surface image of the cargo container;
wherein the top surface image is a photo or a film.

14. The cargo container image capturing system according to claim 13, wherein if the secondary cabinet value is smaller than a secondary cabinet threshold value, the load value is smaller than a load threshold value, and the main crane value is within a predetermined main crane range, then the processing unit determines that the bridge crane meets the state of the cargo container prior to being gripped on the landside;
if the secondary cabinet value is larger than the secondary cabinet threshold value, the main crane value diminishes, and the load value is smaller than the load threshold value, then the processing unit determines that the bridge crane meets a start condition; if the secondary cabinet value is larger than the secondary cabinet threshold value and the load value originally smaller than the load threshold value changes to be larger than the load threshold value, then the processing unit determines that the bridge crane meets a stop condition; and if the bridge crane is within a period between the start condition and the stop condition, then the processing unit determines that the bridge crane meets the state of the cargo container gripped on the seaside;
if the secondary cabinet value is smaller than the secondary cabinet threshold value, the load value is smaller than the load threshold value, and the main crane value is within the predetermined main crane range, then the processing unit determines that the bridge crane meets the state of the cargo container after placement on the landside;
if the secondary cabinet value is larger than the secondary cabinet threshold value, the load value is smaller than the load threshold value, and a value obtained by subtracting a seaside container placement value from the main crane value is within a predetermined sea crane range, then the processing unit determines that the bridge crane meets the state of the cargo container after placement at the seaside.

15. The cargo container image capturing system according to claim 11, wherein the at least one camera comprises four movable pan tilt zoom (PTZ) cameras, and the cargo container image includes four side images of a cargo container.

16. The cargo container image capturing system according to claim 15, wherein the bridge crane further comprises a main crane, and the processing unit is further used to determine whether the main crane is located above a lane according to the secondary cabinet value;
if it is determined that the main crane is located above the lane, then the processing unit controls a filming angle and a focal length of each of the four PTZ cameras to be aligned with the top of the lane;
wherein the processing unit is further used to determine whether the bridge crane meets a gripping state or a placing state according to the variation in the main crane value and the load value;
if the bridge crane meets the gripping state or the placing state, then the processing unit controls the four PTZ cameras to capture the four side images of the cargo container;
wherein the four side images of the cargo container are photos or films.

17. The cargo container image capturing system according to claim 16, wherein if the secondary cabinet value is about equal to a lane threshold value, then the processing unit determines that the main crane is located above the lane;
if the main crane value swells and the load value is larger than a load threshold value, then the processing unit determines that the bridge crane meets the gripping state; and
if the main crane value diminishes and the load value is larger than the load threshold value, then the processing unit determines that the bridge crane meets the placing state.

18. The cargo container image capturing system according to claim 15, wherein the bridge crane further comprises four pillars, and the four PTZ cameras are respectively disposed on the four pillars at a position higher than a height of a front of a container car.
